(19) United States
(12) Patent Application Publication
(10) Pub. No.: US 2024/0239659 A1
(43) Pub. Date: Jul. 18, 2024

(54) LITHIUM SULFIDE PRODUCING DEVICE AND METHOD FOR PRODUCING LITHIUM SULFIDE

(71) Applicant: FURUKAWA CO., LTD., Tokyo (JP)

(72) Inventors: Hiroki Goto, Tsukuba-shi, Ibaraki (JP); Kazutomi Yamamoto, Tsukuba-shi, Ibaraki (JP)

(73) Assignee: FURUKAWA CO., LTD., Tokyo (JP)

(21) Appl. No.: 18/561,885

(22) PCT Filed: May 25, 2022
(86) PCT No.: PCT/JP2022/021350

§ 371 Date: Nov. 17, 2023

(30) Foreign Application Priority Data
May 31, 2021 (JP) 2021-091946
May 31, 2021 (JP) 2021-091947

(51) Int. Cl. C01B 17/22

(52) U.S. Cl. CPC C01B 17/22

(57) ABSTRACT

A lithium sulfide producing device (1-1) of the present invention is a lithium sulfide producing device for producing lithium sulfide by reacting hydrogen sulfide with lithium hydroxide, the lithium sulfide producing device including a reactor (1-3) having a lithium hydroxide filling part (1-2) inside, a heating unit for heating lithium hydroxide, and a hydrogen sulfide supply member connected to the reactor (1-3).

### TECHNICAL FIELD

The present invention relates to a lithium sulfide producing device and a method for producing lithium sulfide.

### BACKGROUND ART

As a method for producing lithium sulfide, a method in which sulfur vapor is generated by heating sulfur placed in a lower portion of a reaction tank, the generated sulfur vapor and hydrogen gas are reacted with each other to generate hydrogen sulfide gas, and lithium sulfide is obtained by reacting the generated hydrogen sulfide gas with lithium hydroxide placed in an upper portion of the reaction tank has been known (Patent Document 1).

Patent Document 1 discloses a method for producing lithium sulfide by synthesizing lithium sulfide with a reaction of lithium hydroxide and hydrogen sulfide, the method including a step (A) of generating a reaction gas containing hydrogen sulfide gas and hydrogen gas by supplying hydrogen gas and sulfur vapor to a porous material which is placed inside a reaction tank and heated, and reacting the hydrogen gas and the sulfur vapor, and a step (B) of producing particulate lithium sulfide by bringing the generated reaction gas into contact with particulate lithium hydroxide to react the hydrogen sulfide gas and the lithium hydroxide. Patent Document 1 discloses that such a production method can reduce the production cost of lithium sulfide, has excellent workability, and can obtain lithium sulfide with high purity.

### RELATED DOCUMENT

### Patent Document

Patent Document 1: Japanese Unexamined Patent Publication No. 2016-150860

### SUMMARY OF THE INVENTION

### Technical Problem

However, it has been difficult to achieve sufficiently high production efficiency with the lithium sulfide production techniques disclosed in Patent Document 1 and the like. In addition, there is also room for improvement in stability of the production efficiency.

The present invention has been made in view of the above-described circumstances, and an object of the present invention is to provide a lithium sulfide producing device capable of stably producing lithium sulfide with high efficiency.

### Solution to Problem

According to the present invention, the following lithium sulfide producing device and method for producing lithium sulfide are provided.
[1]

A lithium sulfide producing device for producing lithium sulfide by reacting hydrogen sulfide with lithium hydroxide, the lithium sulfide producing device including:
a reactor having a lithium hydroxide filling part inside;
a heating unit for heating lithium hydroxide; and
a hydrogen sulfide supply member connected to the reactor.
[2]

The lithium sulfide producing device according to [1],
in which an interior of the reactor includes a heat-insulating member above the lithium hydroxide filling part, and
an upper space and a lower space of the heat-insulating member communicate with each other in a part of the heat-insulating member or around the heat-insulating member.
[3]

The lithium sulfide producing device according to [2], further including:
a heat transfer member disposed in contact with or in close proximity to a bottom surface of the lithium hydroxide filling part.
[4]

The lithium sulfide producing device according to [2] or [3],
in which an inner surface of the device is anti-sulfurized.
[5]

The hydrogen sulfide producing device according to [1], further including:
in which an interior of the reactor includes an inverted funnel-shaped lithium sulfide recovery member above the lithium hydroxide filling part.
[6]

The lithium sulfide producing device according to [5],
in which the inverted funnel-shaped lithium sulfide recovery member also serves as a supply member for the lithium hydroxide.
[7]

The lithium sulfide producing device according to [5] or [6],
in which the inverted funnel-shaped lithium sulfide recovery member is provided to be vertically movable.
[8]

The lithium sulfide producing device according to any one of [5] to [7], further including:
a heat transfer member disposed in contact with or in close proximity to a bottom surface of the lithium hydroxide filling part.
[9]

The lithium sulfide producing device according to any one of [5] to [8],
in which an inner surface is anti-sulfurized.
[10]

A method for producing lithium sulfide, including:
reacting hydrogen sulfide gas and lithium hydroxide using the lithium sulfide producing device according to any one of [1] to [9].

### Advantageous Effects of Invention

According to the present invention, it is possible to provide a lithium sulfide producing device with excellent production efficiency.

### BRIEF DESCRIPTION OF THE DRAWINGS

FIG. 1-1 is a vertical cross-sectional view of a lithium sulfide producing device according to an embodiment 1-1.

FIG. 1-2 is a top view of a heat-insulating member of the lithium sulfide producing device according to the embodiment 1-1.

FIG. 1-3 is a top view of a lithium hydroxide support member of the lithium sulfide producing device according to the embodiment 1-1.

FIG. 1-4 is a vertical cross-sectional view of a lithium sulfide producing device according to an embodiment 1-2.

FIG. 1-5 is a vertical cross-sectional view of a lithium sulfide producing device according to Example 1.

FIG. 1-6 is a vertical cross-sectional view of a lithium sulfide producing device according to Example 2.

FIG. 1-7 is a vertical cross-sectional view of a lithium sulfide producing device according to Reference Example 1.

FIG. 1-8 is a vertical cross-sectional view of a lithium sulfide producing device according to Reference Example 2.

FIG. 1-9 is a graph showing temperatures of reactors in lithium sulfide producing devices of Examples 1 and 2 and Reference Examples 1 and 2.

FIG. 2-1 is a vertical cross-sectional view of a lithium sulfide producing device according to an embodiment 2-1.

FIG. 2-2 is a cross-sectional view and a perspective view of an inverted funnel-shaped lithium sulfide recovery member of the lithium sulfide producing device according to the embodiment 2-1.

FIG. 2-3 is a top view of a lithium hydroxide support member of the lithium sulfide producing device according to the embodiment 2-1.

FIG. 2-4 is a vertical cross-sectional view of a lithium sulfide producing device according to an embodiment 2-2.

FIG. 2-5 is a perspective view showing a specific example of the inverted funnel-shaped lithium sulfide recovery member of the lithium sulfide producing device according to the embodiment 2-1.

### DESCRIPTION OF EMBODIMENTS

Hereinafter, embodiments of the present invention will be described with reference to the drawings. In all the drawings, the same components are represented by common reference numerals, and the description thereof will not be repeated.

The lithium sulfide producing device according to the present invention is a lithium sulfide producing device for producing lithium sulfide by reacting hydrogen sulfide with lithium hydroxide, the lithium sulfide producing device including a reactor having a lithium hydroxide filling part inside, a heating unit for heating lithium hydroxide, and a hydrogen sulfide supply member connected to the reactor.

The lithium sulfide producing device according to the present invention includes the hydrogen sulfide supply member connected to the reactor, and hydrogen sulfide gas is supplied from the hydrogen sulfide supply member. As a result, it is possible to precisely control the amount of hydrogen sulfide gas supplied, and to achieve higher production efficiency. In addition, by precisely controlling the amount of hydrogen sulfide gas supplied, it is possible to maintain the high production efficiency with high stability.

### Embodiment 1-1

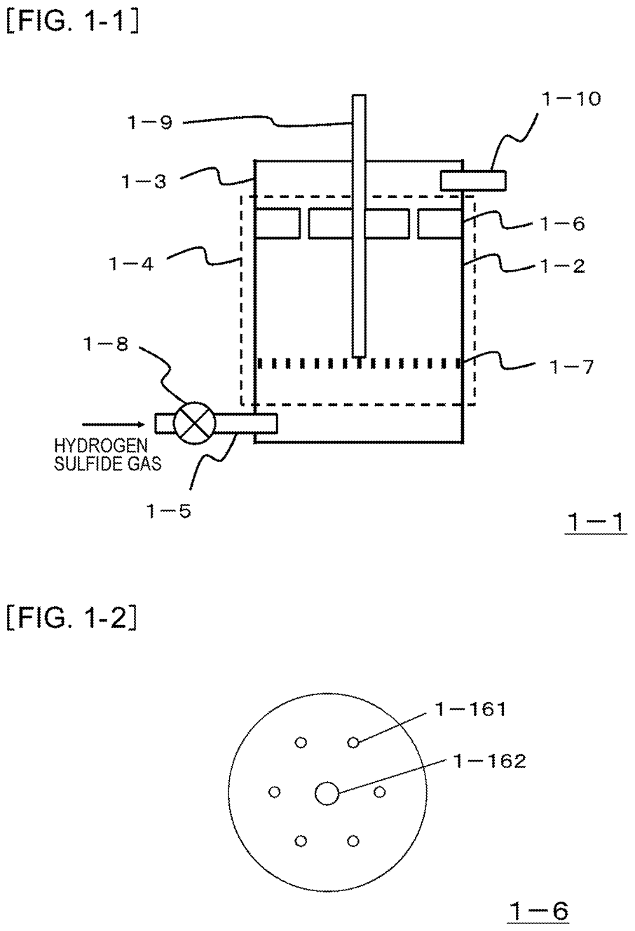

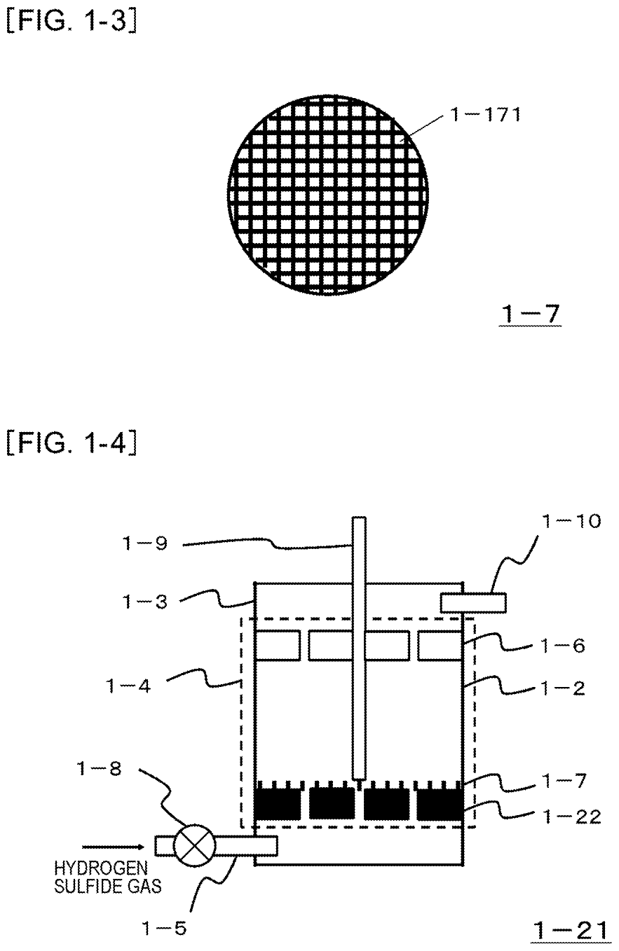

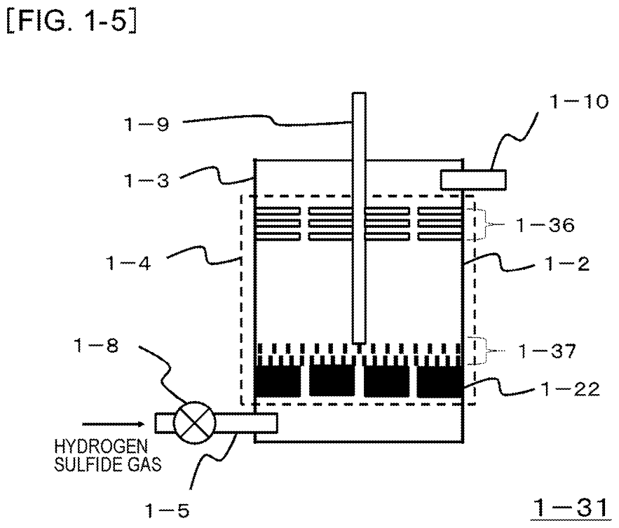

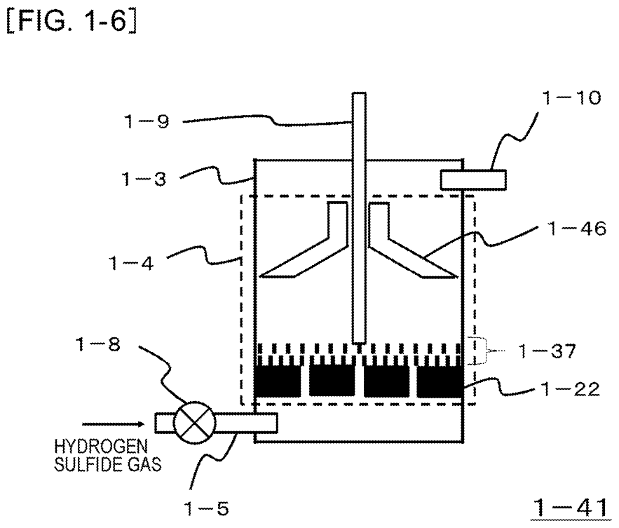

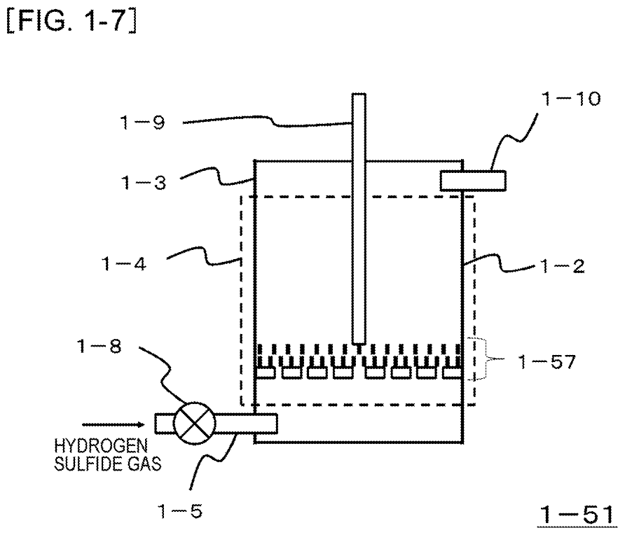

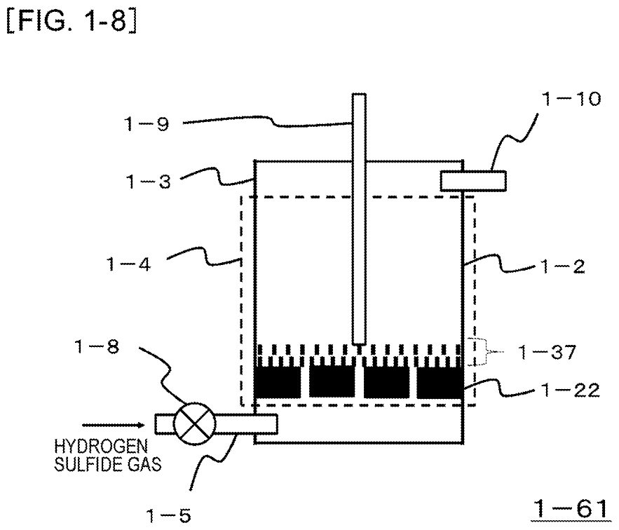

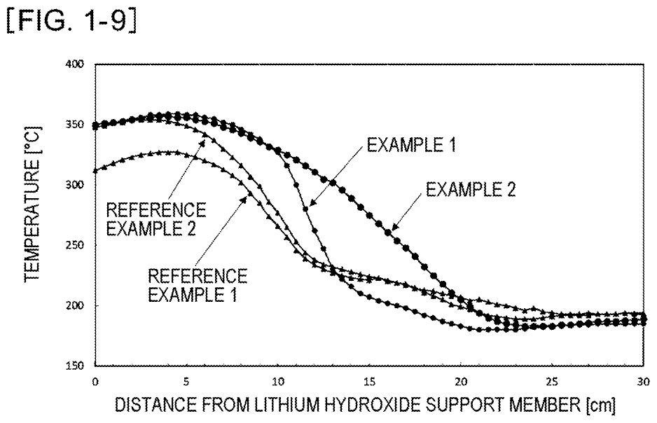

An example of the lithium sulfide producing device of the present embodiment (embodiment 1-1) is shown in FIG. 1-1.

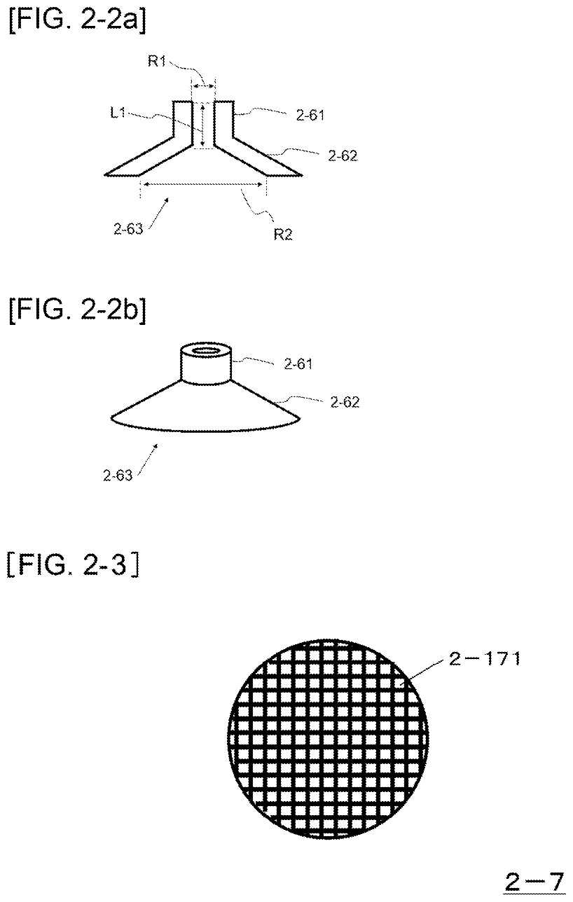

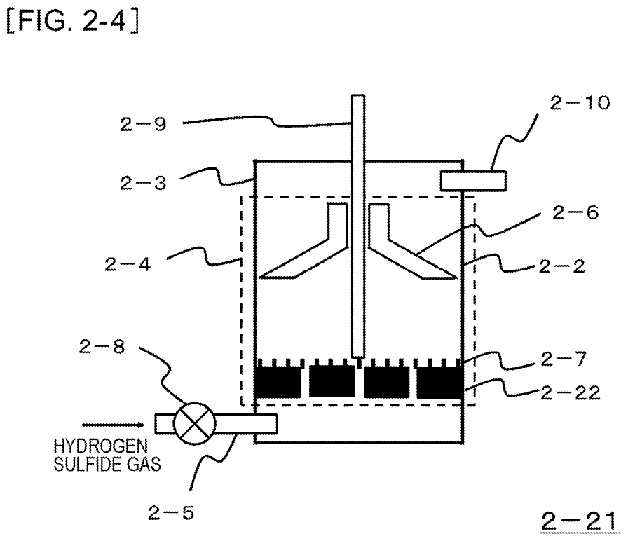

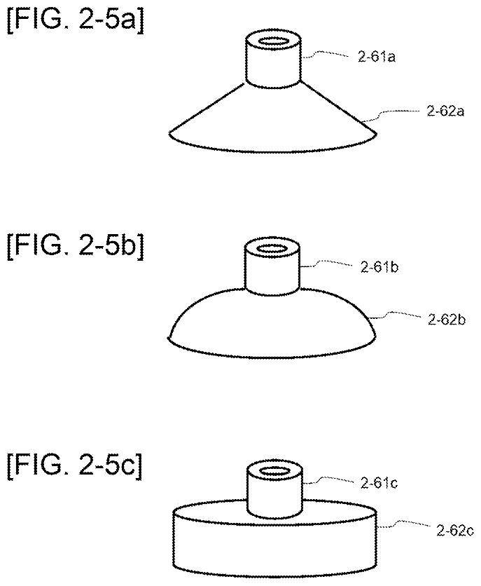

FIG. 1-1 is a vertical cross-sectional view of a lithium sulfide producing device 1-1 according to the embodiment 1-1. FIG. 1-2 is a top view of a heat-insulating member 1-6 included in the lithium sulfide producing device 1-1. FIG. 1-3 is a top view of a lithium hydroxide support member 1-7 included in the lithium sulfide producing device 1-1.

The present inventor conducted various studies on the reason why the production efficiency of lithium sulfide of the lithium sulfide producing device in the related art is not sufficient. As a result, it is found that, by highly controlling a temperature distribution of the lithium hydroxide filling part which is a site of lithium sulfide generation reaction, the lithium sulfide can be stably produced with high efficiency. The lithium sulfide producing device 1-1 has been produced based on such findings.

The lithium sulfide producing device 1-1 includes a reactor 1-3 having a lithium hydroxide filling part 1-2 inside, a jacket heater 1-4 that is a heating unit for heating lithium hydroxide, and a hydrogen sulfide supply pipe 1-5 that is a hydrogen sulfide supply member connected to the reactor 1-3.

In the interior of the reactor 1-3, a heat-insulating member 1-6 is provided above the lithium hydroxide filling part 1-2, an upper space and a lower space of the heat-insulating member 1-6 communicate with each other in a part of the heat-insulating member 1-6 or around the heat-insulating member 1-6.

In the lithium sulfide producing device 1-1 of the present embodiment, since the heat-insulating member 1-6 is provided above the reactor 1-3, release of heat to the outside of the reactor 1-3 is prevented, and the temperature of the entire lithium hydroxide filling part 1-2 is kept high and uniform. Therefore, the reaction site between the hydrogen sulfide gas and the lithium hydroxide is controlled at a high temperature with high accuracy, and lithium sulfide can be stably produced with high production efficiency.

Hereinafter, the configuration of each part of the lithium sulfide producing device of the present embodiment will be described.

### (Reactor 1-3)

Inside the reactor 1-3, lithium sulfide (solid) is produced by the reaction between lithium hydroxide (solid) and hydrogen sulfide gas.

The reactor 1-3 is connected to the hydrogen sulfide supply pipe 1-5, and the hydrogen sulfide is supplied from the hydrogen sulfide supply pipe 1-5.

In addition, the reactor 1-3 is provided with a lithium hydroxide support member 1-7, and a space surrounded by the lithium hydroxide support member 1-7, the heat-insulating member 1-6, and an inner wall of the reactor 1-3 is called the lithium hydroxide filling part 1-2.

Lithium hydroxide (not shown) is placed on the lithium hydroxide support member 1-7.

It is preferable that the hydrogen sulfide supply pipe 1-5 is positioned below the lithium hydroxide support member 1-7. This is because, since the hydrogen sulfide gas is supplied from below to the lithium hydroxide support member 1-7, the hydrogen sulfide gas is ventilated upwardly of the reactor 1-3 and comes into contact with the lithium hydroxide packed in the lithium hydroxide filling part 1-2, so that water (steam) which is a by-product with a lower specific gravity than the hydrogen sulfide gas is efficiently discharged. In addition, fresh hydrogen sulfide gas is continuously supplied by continuously ventilating the hydrogen sulfide gas upwardly of the reactor 1-3.

As shown in FIG. 1-3, it is preferable that the lithium hydroxide support member 1-7 is provided with a plurality of communication holes 1-171. By doing so, the hydrogen sulfide gas supplied from the hydrogen sulfide supply pipe 1-5 is efficiently supplied to the lithium hydroxide filling part 1-2 through the communication holes 1-171.

The hydrogen sulfide gas supplied from the hydrogen sulfide supply pipe 1-5 comes into contact with a surface of the lithium hydroxide (solid) packed in the lithium hydroxide filling part 1-2.

On the surface of lithium hydroxide (solid), it is considered that a reaction such as Formula (1-1) occurs.

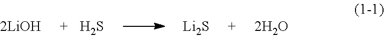

In the lithium hydroxide filling part 1-2 inside the reactor 1-3, it is preferable that the lithium hydroxide is packed in layers, so that the layered lithium hydroxide is in contact with the inner wall surface of the reactor 1-3. This is because, in this way, heating can be performed by heat transfer from the inner wall surface of the lithium hydroxide filling part 1-2, so that heating efficiency can be increased.

From the viewpoint of promoting the above-described reaction and of preventing lithium hydroxide from melting, a temperature of the lithium hydroxide filling part 1-2 is adjusted usually 100° C. to 445° C., preferably 130° C. to 410° C. The temperature of the lithium hydroxide filling part 1-2 is usually measured at a horizontal central portion of the lithium hydroxide filling part 1-2.

As shown in FIG. 1-2, it is preferable that the heat-insulating member 1-6 is provided with a plurality of communication holes 1-161. This is because, by providing a plurality of communication holes 1-161 in the heat-insulating member 1-6, exhaust gas containing unreacted hydrogen sulfide gas and water provided by the reaction of hydrogen sulfide gas and lithium hydroxide is discharged to the outside of the reactor 1-3 through the communication holes 1-161.

Examples of a material of the reactor 1-3 include metals and ceramics, and it is preferable to use a sulfur-resistant material. Examples of the sulfur-resistant material include sulfur-resistant metallic materials such as stainless steel and aluminum, and sulfur-resistant ceramic materials such as quartz, boron nitride, aluminum nitride, and silicon nitride.

It is preferable that the reactor 1-3 has an anti-sulfurized inner surface.

Examples of a method of sulfur-resistant treatment include plating with metal or alloy with high anti-sulfurization performance, such as tin plating, chrome plating, gold plating, hot-dip aluminum plating, and alloy plating containing these metals.

In addition, a metal diffusion permeation treatment may be used as the method of sulfur-resistant treatment. It is known that, when a metal diffusion permeation layer is formed on a surface of the object to be treated by subjecting the object to the metal diffusion permeation treatment, the anti-sulfurization performance is improved.

For example, a calorizing treatment which diffuses and permeates aluminum can be used. In the calorizing treatment, by embedding the object to be treated in a steel case together with a mixture of Fe—Al alloy powder and NH₄Cl powder, sealing the case, and heating it in a furnace, it is possible to form an aluminum diffusion permeation layer in which aluminum is diffused and permeated on the surface of the object to be treated, thereby improving anti-sulfurization performance of the object to be treated.

### (Jacket Heater 1-4)

In the present embodiment, the jacket heater 1-4 is used as the heating unit for heating lithium hydroxide.

That is, the jacket heater 1-4 heats the lithium hydroxide support member 1-7 and the space above the lithium hydroxide support member 1-7. As a result, the lithium hydroxide packed in the lithium hydroxide filling part 1-2 can be heated to promote the lithium sulfide generation reaction.

A temperature of the jacket heater 1-4 is set such that the temperature of the lithium hydroxide filling part 1-2 can be adjusted to the above-described temperature range. Since the necessary heating temperature changes with a diameter of the lithium hydroxide filling part 1-2 and the amount of catalyst filled, the temperature range of the jacket heater 1-4 is not particularly limited, but is preferably 100° C. to 445° C. and more preferably 130° C. to 410° C.

In addition, in the present embodiment, the jacket heater 1-4 is used as the heating unit, but the present invention is not limited thereto, and any heating unit may be used as long as it can heat the lithium hydroxide. For example, a method of introducing heated hydrogen sulfide gas, a high frequency induction heating device, or the like can be used.

### (Hydrogen Sulfide Supply Pipe 1-5)

The hydrogen sulfide supply pipe 1-5 is a member for supplying the hydrogen sulfide gas to the reactor 1-3.

It is preferable that the hydrogen sulfide supply pipe 1-5 is positioned below the lithium hydroxide support member 1-7. This is because, since the hydrogen sulfide gas is supplied from below to the lithium hydroxide support member 1-7, the hydrogen sulfide gas is ventilated upwardly of the reactor 1-3 and comes into contact with the lithium hydroxide packed in the lithium hydroxide filling part 1-2, so that water (steam) which is a by-product with a lower specific gravity than the hydrogen sulfide gas is efficiently discharged. In addition, fresh hydrogen sulfide gas is continuously supplied by continuously ventilating the hydrogen sulfide gas upwardly of the reactor 1-3.

As shown in FIG. 1-1, the hydrogen sulfide supply pipe 1-5 may have a hydrogen sulfide supply control valve 1-8 for controlling the amount of hydrogen sulfide gas supplied. It is possible to adjust the amount of hydrogen sulfide gas supplied by controlling opening and closing of the hydrogen sulfide supply control valve 1-8, and this is preferable from the viewpoint of controlling the lithium sulfide generation reaction carried out in the reactor 1-3.

As a material of the hydrogen sulfide supply pipe 1-5, it is possible to use the material described above as the material of the reactor 1-3.

It is preferable that the hydrogen sulfide supply pipe 1-5 has an anti-sulfurized inner surface. As a method of the anti-sulfur treatment, the above-described method as the method used for the anti-sulfur treatment of the inner surface of the reactor 1-3 can be used.

In addition, in the present embodiment, the hydrogen sulfide supply pipe 1-5 is used as the hydrogen sulfide supply member, but the present invention is not limited thereto, and any hydrogen sulfide supply member may be used as long as it can supply the hydrogen sulfide gas to the reactor 1-3.

### (Heat-Insulating Member 1-6)

The heat-insulating member 1-6 is a member for insulating the interior of the reactor 1-3, and is provided above the lithium hydroxide filling part 1-2.

As shown in FIG. 1-1, it is preferable that the heat-insulating member 1-6 is disposed above the lithium hydroxide filling part 1-2 to cover the entire lithium hydroxide filling part 1-2. By doing so, the release of heat to the outside of the reactor 1-3 is further prevented.

In addition, as shown in FIG. 1-1, it is preferable that a side surface of the heat-insulating member 1-6 is provided to be in contact with the inner wall of the reactor 1-3. By doing so, the heat-insulating member 1-6 is also heated, and since the heat-insulating member 1-6 itself has a certain heat capacity, heat-insulating effect of the heat-insulating member 1-6 is further enhanced.

As shown in FIG. 1-2, it is preferable that the heat-insulating member 1-6 is provided with a plurality of communication holes 1-161. This is because, by providing a plurality of communication holes 1-161 in the heat-insulating member 1-6, exhaust gas containing unreacted hydrogen sulfide gas and water provided by the reaction of hydrogen sulfide gas and lithium hydroxide is discharged to the outside of the reactor 1-3 through the communication holes 1-161.

In addition, as shown in FIG. 1-2, the heat-insulating member 1-6 may be provided with a through hole 1-162 for temperature sensor. In this case, a temperature sensor 1-9 inserted from above the reactor 1-3 is connected to the reactor 1-3 by passing through the through hole 1-162 for temperature sensor.

As a material of the heat-insulating member 1-6, it is possible to use the material described above as the material of the reactor 1-3.

A shape of the heat-insulating member 1-6 is not particularly limited, but it is preferable that the heat-insulating member 1-6 has a plurality of communication holes 1-161 as described above. For example, it is possible to use one or two or more porous materials selected from metal mesh such as stainless steel mesh and aluminum mesh, punching metal such as stainless steel punching and aluminum punching, and expanded metal such as expanded stainless steel and expanded aluminum.

As necessary, two or more of the above-described porous materials may be stacked and used as the heat-insulating member 1-6.

From the viewpoint of balance between improvement of heat-insulating efficiency and improvement of recovery of exhaust gas and the like, an area ratio of the communication hole 1-161 provided in the heat-insulating member 1-6 is usually equal to or more than 0.2% and equal to or less than 50%, preferably equal to or more than 0.5% and equal to or less than 40%.

From the viewpoint of balance between improvement of heat-insulating efficiency and improvement of recovery of exhaust gas and the like, a diameter of the communication hole 1-161 provided in the heat-insulating member 1-6 is usually equal to or more than 26 μm and equal to or less than 10,000 μm, preferably equal to or more than 45 μm and equal to or less than 5,000 μm.

From the viewpoint of improving heat-insulating efficiency, a thickness of the heat-insulating member 1-6 is preferably equal to or more than 0.5 mm, and more preferably equal to or more than 1.5 mm. In addition, there is no particular upper limit to the thickness of the heat-insulating member 1-6, but the thickness thereof is usually equal to or less than 20 mm.

As for a shape of the heat-insulating member, an inverted funnel-shaped heat-insulating member 1-46 as shown in FIG. 1-6 may be used.

When the inverted funnel-shaped heat-insulating member 1-46 is used as the heat-insulating member, the temperature sensor 1-9 can be inserted into a leg part of the inverted funnel-shaped heat-insulating member 1-46 and connected to the lithium hydroxide filling part 1-2. In this case, a gap is formed between the temperature sensor 1-9 and an inner wall of the leg part of the inverted funnel-shaped heat-insulating member 1-46, so that the gap allows communication between an upper space and a lower space of the inverted funnel-shaped heat-insulating member 1-46.

### (Lithium Hydroxide Support Member 1-7)

The lithium hydroxide support member 1-7 is a member for placing lithium hydroxide.

As described above, in order to enable heating by heat transfer from the inner wall surface of the reactor 1-3, it is preferable that the lithium hydroxide is packed in layers to be in contact with the inner wall of the lithium hydroxide filling part 1-2. Therefore, it is preferable that the lithium hydroxide support member 1-7 is disposed to be in contact with the inner wall of the lithium hydroxide filling part 1-2 so that the lithium hydroxide can be placed in this way.

As shown in FIG. 1-3, it is preferable that the lithium hydroxide support member 1-7 is provided with a plurality of communication holes 1-171. This is because, by providing a plurality of communication holes 1-171 in the lithium hydroxide support member 1-7, the hydrogen sulfide supplied from the hydrogen sulfide supply pipe 1-5 is efficiently supplied to the lithium hydroxide filling part 1-2 through the plurality of communication holes 1-171.

As a material of the lithium hydroxide support member 1-7, it is possible to use the material described above as the material of the reactor 1-3.

A shape of the lithium hydroxide support member 1-7 is not particularly limited as long as the lithium hydroxide can be placed thereon, but it is preferable that the lithium hydroxide support member 1-7 has a plurality of communication holes 1-171 as described above. For example, it is possible to use one or two or more porous materials selected from metal mesh such as stainless steel mesh and aluminum mesh, punching metal such as stainless steel punching and aluminum punching, and expanded metal such as expanded stainless steel.

As necessary, two or more of the above-described porous materials may be stacked and used as the lithium hydroxide support member 1-7.

A diameter of the communication hole 1-171 provided in the lithium hydroxide support member 1-7 depends on a diameter of the lithium hydroxide to be placed, but is usually equal to or more than 26 μm and equal to or less than 300 μm, preferably equal to or more than 45 μm and equal to or less than 154 μm.

### (Gas Discharge Pipe 1-10)

The gas discharge pipe 1-10 is a member for discharging the exhaust gas containing unreacted hydrogen sulfide and water provided by the reaction of hydrogen sulfide gas and lithium hydroxide to the outside of the reactor 1-3.

It is preferable that the gas discharge pipe 1-10 is positioned above the lithium hydroxide support member 1-7. This is because the by-product water (steam) and the unreacted hydrogen sulfide gas are ventilated upwardly of the reactor 1-3, so that gas discharge is more efficient when the gas discharge pipe 1-10 is provided upward. By improving the efficiency of gas discharge, fresh hydrogen sulfide gas is continuously supplied.

It is preferable that the gas discharge pipe 1-10 is provided with a cooling part for capturing water produced by the reaction between hydrogen sulfide gas and lithium hydroxide. When the reaction between hydrogen sulfide gas and lithium hydroxide is completed, the water generated when lithium sulfide is produced is no longer condense in the cooling part. That is, the progress of the lithium sulfide generation reaction can be monitored by the amount of condensed water.

### (Temperature Sensor 1-9)

The temperature sensor 1-9 is a member for measuring the temperature inside the reactor 1-3. For example, by measuring the temperature inside the reactor 1-3 with the temperature sensor 1-9 and adjusting the heating based on the measurement result, it is possible to control the production of lithium sulfide at a higher level.

### Embodiment 1-2

An example of the lithium sulfide producing device of the present embodiment (embodiment 1-2) is shown in FIG. 1-4.

FIG. 1-4 is a vertical cross-sectional view of a lithium sulfide producing device 1-21 according to the embodiment 1-2.

The lithium sulfide producing device 1-21 further includes a heat transfer member 1-22 disposed in contact with or in close proximity to a bottom surface of the lithium hydroxide filling part 1-2. By providing the heat transfer member 1-22 under the lithium hydroxide filling part 1-2, heat from the jacket heater 1-4 covering the outside of the reactor 1-3 is easily conducted in a cross-sectional horizontal direction of the lithium hydroxide filling part 1-2, and heat uniformity in the horizontal direction of the lithium hydroxide filling part 1-2 is improved.

It is preferable that the heat transfer member 1-22 is disposed to be in contact with an inner wall of the lithium hydroxide filling part 1-2. This is for more efficient transmission of heat from the jacket heater 1-4 covering the outside of the reactor 1-3.

It is preferable that the heat transfer member 1-22 is provided with a plurality of communication holes. This is because, by providing a plurality of communication holes in the heat transfer member 1-22, the hydrogen sulfide supplied from the hydrogen sulfide supply pipe 1-5 is efficiently supplied to the lithium hydroxide filling part 1-2 through the plurality of communication holes.

A material of the heat transfer member 1-22 is not particularly limited, and the materials described above as the material of the reactor 1-3 can be used. However, it is preferable to use a material having excellent resistance to sulfurization and thermal conductivity, and for example, it is preferable to use aluminum, aluminum alloy, aluminum nitride, silicon nitride, or the like.

In addition, a shape of the heat transfer member 1-22 is not particularly limited, but it is preferable that the heat transfer member 1-22 has a plurality of communication holes such as punching metal. For example, it is possible to use one or two or more porous materials selected from metal mesh such as stainless steel mesh and aluminum mesh, punching metal such as stainless steel punching and aluminum punching, and expanded metal such as expanded stainless steel and expanded aluminum.

As necessary, two or more of the above-described porous materials may be stacked and used as the heat transfer member 1-22.

From the viewpoint of balance between improvement of heat transfer efficiency and improvement of catalyst contact efficiency between sulfur vapor and catalyst, an area ratio of the communication hole provided in the heat transfer member 1-22 is usually equal to or more than 0.2% and equal to or less than 50%, preferably equal to or more than 0.5% and equal to or less than 40%.

A diameter of the communication hole provided in the heat transfer member 1-22 is usually equal to or more than 26 μm and equal to or less than 10,000 μm, preferably equal to or more than 45 μm and equal to or less than 5,000 μm.

### [Method for Producing Lithium Sulfide by Lithium Sulfide Producing Device of Embodiment 1-1 or 1-2]

A method for producing lithium sulfide using the lithium sulfide producing device of the embodiment 1-1 or 1-2 will be described.

First, the lithium hydroxide filling part 1-2 is filled with lithium hydroxide, and the lithium hydroxide filling part 1-2 filled with lithium hydroxide is heated by the jacket heater 1-4 as a heating unit. Next, hydrogen sulfide gas is supplied to the lithium hydroxide filling part 1-2 to bring the hydrogen sulfide gas into contact with the lithium hydroxide, and lithium sulfide is produced by the reaction between the lithium hydroxide and the hydrogen sulfide gas.

Since the heat-insulating member 1-6 is provided above in the upper portion of the reactor 1-3 in the lithium sulfide producing device 1-1, release of heat to the outside of the reactor 1-3 is prevented, and the temperature of the entire lithium hydroxide filling part 1-2 is kept high and uniform. Therefore, the lithium sulfide producing device 1-1 can stably produce lithium sulfide with high efficiency.

In the production process of lithium sulfide using the lithium sulfide producing device 1-1, a temperature of the lithium hydroxide filling part 1-2 in all regions is usually equal to or higher than 100° C., preferably equal to or higher than 130° C., more preferably equal to or higher than 150° C., still more preferably equal to or higher than 170° C., and even more preferably equal to or higher than 200° C.

When the temperature of the lithium hydroxide filling part 1-2 in all regions is equal to or higher than the above-described lower limit value, a reaction rate between hydrogen sulfide gas and lithium hydroxide can be further improved.

In the production process of lithium sulfide using the lithium sulfide producing device 1-1, the temperature of the lithium hydroxide filling part 1-2 in all regions is preferably equal to or lower than 445° C., more preferably equal to or lower than 430° C., and still more preferably equal to or lower than 410° C. When the temperature of the catalyst filling part in all regions is equal to or lower than the above-described upper limit value, since it is possible to suppress the lithium hydroxide from melting, it is possible to suppress fusion between the lithium hydroxides to form lumps. As a result, a reaction between a reaction gas and lithium hydroxide can proceed more effectively.

In the production process of lithium sulfide using the lithium sulfide producing device 1-1, a difference between the maximum temperature Tₘₐₓ and the minimum temperature Tₘᵢₙ, which are temperatures measured at each point of the lithium hydroxide filling part 1-2, (Tₘₐₓ−Tₘᵢₙ) is preferably equal to or lower than 50° C., more preferably equal to or lower than 30° C., and still more preferably equal to or lower than 20° C., and it is preferable to be as small as possible. When Tₘₐₓ−Tₘᵢₙ is small, that is, when the variation in temperature at each point of the lithium hydroxide filling part 1-2 is small, the reaction between hydrogen sulfide gas and lithium hydroxide can proceed more efficiently and stably.

d₅₀ of the lithium hydroxide in a weight-based particle size distribution measured by a laser diffraction scattering particle size distribution measurement method is preferably equal to or less than 1.5 mm, and more preferably equal to or less than 1.0 mm. When d₅₀ is equal to or less than the above-described upper limit value, a contact area between lithium hydroxide and the reaction gas is increased to promote the reaction, so that the amount of unreacted raw materials in the obtained lithium sulfide can be further reduced. As a result, higher purity lithium sulfide can be obtained.

In addition, d₅₀ of the lithium hydroxide in the weight-based particle size distribution measured by a laser diffraction scattering particle size distribution measurement method is preferably equal to or more than 0.1 mm, and more preferably equal to or more than 0.2 mm. When d₅₀ is equal to or more than the above-described lower limit value, water generated in the reaction system can be prevented from adhering to lithium sulfide particles and causing the particles to stick. In addition, since it is possible to suppress the discharge of lithium hydroxide and obtained lithium sulfide together with the reaction gas, the exhaust gas treatment can be made simpler. Furthermore, since it is possible to suppress scattering of lithium hydroxide and obtained lithium sulfide by the reaction gas, the yield of lithium sulfide can be improved.

It is preferable that the lithium hydroxide is subjected in advance to dehydration of water of crystallization and drying of adhering water. As a result, since it is possible to suppress lithium hydroxide from agglomerating and suppress formation of hydrosulfide, the reaction between hydrogen sulfide gas and lithium hydroxide can proceed more effectively. Examples of dehydrating or drying the lithium hydroxide include a method of heating in the atmosphere, a method of heating while flowing a gas such as hydrogen, nitrogen, and argon gas, and a method of heating under reduced pressure.

The hydrogen sulfide gas may be a commercial product filled in a gas cylinder or the like, or may be produced by a hydrogen sulfide producing device connected upstream of the lithium sulfide producing device 1-1.

When a hydrogen sulfide producing device is connected upstream of the lithium sulfide producing device 1-1, it is possible to generate hydrogen sulfide gas in an amount necessary for producing lithium sulfide, which eliminates the need to store hydrogen sulfide gas separately. In addition, since the hydrogen sulfide gas can be generated as needed, high-purity hydrogen sulfide gas which does not degrade over time can be used for the reaction.

### Embodiment 2-1

An example of the lithium sulfide producing device of the present embodiment (embodiment 2-1) is shown in FIG. 2-1.

FIG. 2-1 is a vertical cross-sectional view of a lithium sulfide producing device 2-1 according to the embodiment 2-1. FIG. 2-2a is a vertical cross-sectional view of an inverted funnel-shaped lithium sulfide recovery member 2-6 included in the lithium sulfide producing device 2-1 of the present embodiment. FIG. 2-2b is a perspective view of the inverted funnel-shaped lithium sulfide recovery member 2-6 included in the lithium sulfide producing device 2-1 of the present embodiment. FIG. 2-3 is a top view of a lithium hydroxide support member 2-7 included in the lithium sulfide producing device 2-1.

The lithium sulfide producing device 2-1 includes a reactor 2-3 having a lithium hydroxide filling part 2-2 inside, a jacket heater 2-4 that is a heating unit for heating lithium hydroxide, and a hydrogen sulfide supply pipe 2-5 that is a hydrogen sulfide supply member connected to the reactor 2-3. An interior of the reactor 2-3 includes an inverted funnel-shaped lithium sulfide recovery member 2-6 above the lithium hydroxide filling part 2-2.

In the lithium sulfide producing device 2-1 of the present embodiment, since the inverted funnel-shaped lithium sulfide recovery member 2-6 is provided above the reactor 2-3, lithium sulfide produced in the reactor 2-3 can be recovered by sucking the lithium sulfide from a leg part of the inverted funnel-shaped lithium sulfide recovery member 2-6. Therefore, the lithium sulfide can be recovered without dismantling the lithium sulfide producing device 2-1, recovery efficiency of lithium sulfide increases, and the lithium sulfide can be produced with high production efficiency.

Hereinafter, the configuration of each part of the lithium sulfide producing device of the present embodiment will be described.

### (Reactor 2-3)

Inside the reactor 2-3, lithium sulfide (solid) is produced by the reaction between lithium hydroxide (solid) and hydrogen sulfide gas.

The reactor 2-3 is connected to the hydrogen sulfide supply pipe 2-5, and the hydrogen sulfide is supplied from the hydrogen sulfide supply pipe 2-5.

In addition, the reactor 2-3 is provided with a lithium hydroxide support member 2-7, and a space surrounded by the lithium hydroxide support member 2-7 and an inner wall of the reactor 2-3 is called the lithium hydroxide filling part 2-2.

Lithium hydroxide (not shown) is placed on the lithium hydroxide support member 2-7.

It is preferable that the hydrogen sulfide supply pipe 2-5 is positioned below the lithium hydroxide support member 2-7. This is because, since the hydrogen sulfide gas is supplied from below to the lithium hydroxide support member 2-7, the hydrogen sulfide gas is ventilated upwardly of the reactor 2-3 and comes into contact with the lithium hydroxide packed in the lithium hydroxide filling part 2-2, so that water (steam) which is a by-product with a lower specific gravity than the hydrogen sulfide gas is efficiently discharged. In addition, fresh hydrogen sulfide gas is continuously supplied by continuously ventilating the hydrogen sulfide gas upwardly of the reactor 2-3.

As shown in FIG. 2-3, it is preferable that the lithium hydroxide support member 2-7 is provided with a plurality of communication holes 2-171. By doing so, the hydrogen sulfide gas supplied from the hydrogen sulfide supply pipe 2-5 is efficiently supplied to the lithium hydroxide filling part 2-2 through the communication holes 2-171.

The hydrogen sulfide gas supplied from the hydrogen sulfide supply pipe 2-5 comes into contact with a surface of the lithium hydroxide (solid) packed in the lithium hydroxide filling part 2-2.

On the surface of lithium hydroxide (solid), it is considered that a reaction such as Formula (2-1) occurs.

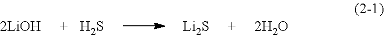

In the lithium hydroxide filling part 2-2 inside the reactor 2-3, it is preferable that the lithium hydroxide is packed in layers, so that the layered lithium hydroxide is in contact with the inner wall surface of the reactor 2-3. This is because, in this way, heating can be performed by heat transfer from the inner wall surface of the lithium hydroxide filling part 2-2, so that heating efficiency can be increased.

From the viewpoint of promoting the above-described reaction and of preventing lithium hydroxide from melting, a temperature of the lithium hydroxide filling part 2-2 is adjusted usually 100° C. to 445° C., preferably 130° C. to 410° C. The temperature of the lithium hydroxide filling part 2-2 is usually measured at a horizontal central portion of the lithium hydroxide filling part 2-2.

Examples of a material of the reactor 2-3 include metals and ceramics, and it is preferable to use a sulfur-resistant material. Examples of the sulfur-resistant material include sulfur-resistant metallic materials such as stainless steel and aluminum, and sulfur-resistant ceramic materials such as quartz, boron nitride, aluminum nitride, and silicon nitride.

It is preferable that the reactor 2-3 has an anti-sulfurized inner surface.

Examples of a method of sulfur-resistant treatment include plating with metal or alloy with high anti-sulfurization performance, such as tin plating, chrome plating, gold plating, hot-dip aluminum plating, and alloy plating containing these metals.

In addition, a metal diffusion permeation treatment may be used as the method of sulfur-resistant treatment. It is known that, when a metal diffusion permeation layer is formed on a surface of the object to be treated by subjecting the object to the metal diffusion permeation treatment, the anti-sulfurization performance is improved.

For example, a calorizing treatment which diffuses and permeates aluminum can be used. In the calorizing treatment, by embedding the object to be treated in a steel case together with a mixture of Fe—Al alloy powder and NH₄Cl powder, sealing the case, and heating it in a furnace, it is possible to form an aluminum diffusion permeation layer in which aluminum is diffused and permeated on the surface of the object to be treated, thereby improving anti-sulfurization performance of the object to be treated.

### (Jacket Heater 2-4)

In the present embodiment, the jacket heater 2-4 is used as the heating unit for heating lithium hydroxide.

That is, the jacket heater 2-4 heats the lithium hydroxide support member 2-7 and the space above the lithium hydroxide support member 2-7. As a result, the lithium hydroxide packed in the lithium hydroxide filling part 2-2 can be heated to promote the lithium sulfide generation reaction.

A temperature of the jacket heater 2-4 is set such that the temperature of the lithium hydroxide filling part 2-2 can be adjusted to the above-described temperature range. Since the necessary heating temperature changes with a diameter of the lithium hydroxide filling part 2-2 and the amount of catalyst filled, the temperature range of the jacket heater 2-4 is not particularly limited, but is preferably 100° C. to 445° C. and more preferably 130° C. to 410° C.

In addition, in the present embodiment, the jacket heater 2-4 is used as the heating unit, but the present invention is not limited thereto, and any heating unit may be used as long as it can heat the lithium hydroxide. For example, a method of introducing heated hydrogen sulfide gas, a high frequency induction heating device, or the like can be used.

### (Hydrogen Sulfide Supply Pipe 2-5)

The hydrogen sulfide supply pipe 2-5 is a member for supplying the hydrogen sulfide gas to the reactor 2-3.

It is preferable that the hydrogen sulfide supply pipe 2-5 is positioned below the lithium hydroxide support member 2-7. This is because, since the hydrogen sulfide gas is supplied from below to the lithium hydroxide support member 2-7, the hydrogen sulfide gas is ventilated upwardly of the reactor 2-3 and comes into contact with the lithium hydroxide packed in the lithium hydroxide filling part 2-2, so that water (steam) which is a by-product with a lower specific gravity than the hydrogen sulfide gas is efficiently discharged. In addition, fresh hydrogen sulfide gas is continuously supplied by continuously ventilating the hydrogen sulfide gas upwardly of the reactor 2-3.

As shown in FIG. 2-1, the hydrogen sulfide supply pipe 2-5 may have a hydrogen sulfide supply control valve 2-8 for controlling the amount of hydrogen sulfide gas supplied. It is possible to adjust the amount of hydrogen sulfide supplied by controlling opening and closing of the hydrogen sulfide supply control valve 2-8, and this is preferable from the viewpoint of controlling the lithium sulfide generation reaction carried out in the reactor 2-3.

As a material of the hydrogen sulfide supply pipe 2-5, it is possible to use the material described above as the material of the reactor 2-3.

It is preferable that the hydrogen sulfide supply pipe 2-5 has an anti-sulfurized inner surface. As a method of the anti-sulfur treatment, the above-described method as the method used for the anti-sulfur treatment of the inner surface of the reactor 2-3 can be used.

In addition, in the present embodiment, the hydrogen sulfide supply pipe 2-5 is used as the hydrogen sulfide supply member, but the present invention is not limited thereto, and any hydrogen sulfide supply member may be used as long as it can supply the hydrogen sulfide gas to the reactor 2-3.

### (Inverted Funnel-Shaped Lithium Sulfide Recovery Member 2-6)

The inverted funnel-shaped lithium sulfide recovery member 2-6 is an inverted funnel-shaped member provided above the lithium hydroxide filling part 2-2, and includes a leg part 2-61 and a body part 2-62. In addition, an opening part 2-63 is provided in the body part 2-62.

In the inverted funnel-shaped lithium sulfide recovery member 2-6, the leg part 2-61 of the inverted funnel-shaped member 2-6 functions as a lithium sulfide recovery part. That is, the lithium sulfide is recovered by connecting a recovery device to the leg part 2-61 which is a lithium sulfide recovery part. With the inverted funnel-shaped lithium sulfide recovery member 2-6, the lithium sulfide can be recovered without dismantling the lithium sulfide producing device 2-1, and recovery efficiency of lithium sulfide is improved.

Any device can be used as the recovery device. For example, when a suction type recovery device is used, a suction member such as a suction tube is connected to the leg part 2-61, and the lithium sulfide is recovered by suctioning the lithium sulfide into the suction type recovery device through the suction member. In this case, the suction member may be provided with a filter.

Since the inverted funnel-shaped lithium sulfide recovery member 2-6 is shaped like an inverted funnel, an inner diameter of the opening part 2-63 is larger than an inner diameter of the leg part 2-61. Therefore, since the opening part 2-63 having a large inner diameter can suck a wide area, the lithium sulfide in the reactor 2-3 can be recovered more efficiently.

In the lithium sulfide producing device 2-1 of the present embodiment, the leg part 2-61 of the inverted funnel-shaped lithium sulfide recovery member 2-6 can communicate an upper space and a lower space of the inverted funnel-shaped lithium sulfide recovery member 2-6. In this manner, by-product water (steam) of the lithium sulfide generation reaction and the unreacted hydrogen sulfide gas move to the upper space of the inverted funnel-shaped lithium sulfide recovery member 2-6, and are recovered from the gas discharge pipe 2-10.

It is preferable that the inverted funnel-shaped lithium sulfide recovery member 2-6 also functions as a lithium hydroxide introduction part.

When the inverted funnel-shaped lithium sulfide recovery member 2-6 also functions as a lithium hydroxide introduction part, the lithium hydroxide is filled from the leg part 2-61 of the inverted funnel-shaped lithium sulfide recovery member 2-6. In this case, since dust generated when the lithium hydroxide is filled is guarded by an inner wall of the body part 2-62, the filling of the lithium hydroxide can be performed more efficiently.

It is preferable that the inverted funnel-shaped lithium sulfide recovery member 2-6 is provided to be vertically movable. By doing so, the inverted funnel-shaped lithium sulfide recovery member 2-6 can advance to the vicinity of the bottom of the reactor 2-3, and the lithium sulfide can be efficiently recovered.

It is preferable that the inverted funnel-shaped lithium sulfide recovery member 2-6 is disposed so that a gap (clearance) is provided between the inverted funnel-shaped lithium sulfide recovery member 2-6 and the inner wall of the reactor 2-3. When a gap is provided between the inverted funnel-shaped lithium sulfide recovery member 2-6 and the inner wall of the reactor 2-3 and the volume of lithium sulfide packed in the reactor 2-3 decreases due to recovery, the inverted funnel-shaped lithium sulfide recovery member 2-6 can move downward accordingly.

A shape of the inverted funnel-shaped lithium sulfide recovery member 2-6 is not particularly limited, but from the viewpoint of improving recovery efficiency of lithium sulfide, a ratio (L1/R1) between an inner diameter R1 of the leg part 2-61 and a length L1 of the leg part 2-61 is preferably 1.0 to 10, and more preferably 1.6 to 2.5.

A shape of the inverted funnel-shaped lithium sulfide recovery member 2-6 is not particularly limited, but from the viewpoint of improving recovery efficiency of lithium sulfide, a ratio (R2/R1) between the inner diameter R1 of the leg part 2-61 and an inner diameter R2 of the opening part 2-63 is preferably 2.0 to 20, and more preferably 4.0 to 12.

As a material of the inverted funnel-shaped lithium sulfide recovery member 2-6, it is possible to use the material described above as the material of the reactor 2-3.

In addition, an inner wall of the inverted funnel-shaped lithium sulfide recovery member 2-6 may be provided with grooves or unevenness. By providing grooves or unevenness, since the lithium sulfide is less likely to adhere to the inner wall of the inverted funnel-shaped lithium sulfide recovery member 2-6 during lithium sulfide recovery, the recovery can be performed more efficiently. In addition, by subjecting antistatic treatment to the inner wall of the inverted funnel-shaped lithium sulfide recovery member 2-6, the lithium sulfide can also be made difficult to adhere.

In addition, the body part of the inverted funnel-shaped lithium sulfide recovery member 2-6 may be a combination of a conical body part 2-63a as shown in FIG. 2-5a with a leg part 2-61a, may be a combination of a hemispherical body part 2-63b as shown in FIG. 2-5b with a leg part 2-61b, or may be a combination of a cylindrical body part 2-63c as shown in FIG. 2-5c with a leg part 2-61c.

When the lithium sulfide producing device 2-1 of the present embodiment includes a temperature sensor 2-9, the temperature sensor 2-9 can be inserted into the leg part 2-61 of the inverted funnel-shaped lithium sulfide recovery member 2-6 and connected to the lithium hydroxide filling part 2-2. In this case, a gap is formed between the temperature sensor 2-9 and an inner wall of the leg part 2-61 of the inverted funnel-shaped lithium sulfide recovery member 2-6, so that the gap allows communication between an upper space and a lower space of the inverted funnel-shaped lithium sulfide recovery member 2-6.

### (Lithium Hydroxide Support Member 2-7)

The lithium hydroxide support member 2-7 is a member for placing lithium hydroxide.

As described above, in order to enable heating by heat transfer from the inner wall surface of the reactor 2-3, it is preferable that the lithium hydroxide is packed in layers to be in contact with the inner wall of the lithium hydroxide filling part 2-2. Therefore, it is preferable that the lithium hydroxide support member 2-7 is disposed to be in contact with the inner wall of the lithium hydroxide filling part 2-2 so that the lithium hydroxide can be placed in this way.

As shown in FIG. 2-3, it is preferable that the lithium hydroxide support member 2-7 is provided with a plurality of communication holes 2-171. This is because, by providing a plurality of communication holes 2-171 in the lithium hydroxide support member 2-7, the hydrogen sulfide supplied from the hydrogen sulfide supply pipe 2-5 is efficiently supplied to the lithium hydroxide filling part 2-2 through the plurality of communication holes 2-171.

As a material of the lithium hydroxide support member 2-7, it is possible to use the material described above as the material of the reactor 2-3.

A shape of the lithium hydroxide support member 2-7 is not particularly limited as long as the lithium hydroxide can be placed thereon, but it is preferable that the lithium hydroxide support member 2-7 has a plurality of communication holes 2-171 as described above. For example, it is possible to use one or two or more porous materials selected from metal mesh such as stainless steel mesh and aluminum mesh, punching metal such as stainless steel punching and aluminum punching, and expanded metal such as expanded stainless steel and expanded aluminum.

As necessary, two or more of the above-described porous materials may be stacked and used as the lithium hydroxide support member 2-7.

A diameter of the communication hole 2-171 provided in the lithium hydroxide support member 2-7 depends on a diameter of the lithium hydroxide to be placed, but is usually equal to or more than 26 μm and equal to or less than 300 μm, preferably equal to or more than 45 μm and equal to or less than 154 μm.

### (Gas Discharge Pipe 2-10)

The gas discharge pipe 2-10 is a member for discharging the exhaust gas containing unreacted hydrogen sulfide and water provided by the reaction of hydrogen sulfide gas and lithium hydroxide to the outside of the reactor 2-3.

It is preferable that the gas discharge pipe 2-10 is positioned above the lithium hydroxide support member 2-7. This is because the by-product water (steam) and the unreacted hydrogen sulfide gas are ventilated upwardly of the reactor 2-3, so that gas discharge is more efficient when the gas discharge pipe 2-10 is provided upward. By improving the efficiency of gas discharge, fresh hydrogen sulfide gas is continuously supplied.

It is preferable that the gas discharge pipe 2-10 is provided with a cooling part for capturing water produced by the reaction between hydrogen sulfide gas and lithium hydroxide.

When the reaction between hydrogen sulfide gas and lithium hydroxide is completed, the water generated when lithium sulfide is produced is no longer condense in the cooling part. That is, the progress of the lithium sulfide generation reaction can be monitored by the amount of condensed water.

### (Temperature Sensor 2-9)

The temperature sensor 2-9 is a member for measuring the temperature inside the reactor 2-3. For example, by measuring the temperature inside the reactor 2-3 with the temperature sensor 2-9 and adjusting the heating based on the measurement result, it is possible to control the production of lithium sulfide at a higher level.

### Embodiment 2-2

An example of the lithium sulfide producing device of the present embodiment (embodiment 2-2) is shown in FIG. 2-4.

FIG. 2-4 is a vertical cross-sectional view of a lithium sulfide producing device 2-21 according to the embodiment 2-2.

The lithium sulfide producing device 2-21 further includes a heat transfer member 2-22 disposed in contact with or in close proximity to a bottom surface of the lithium hydroxide filling part 2-2.

By providing the heat transfer member 2-22 under the lithium hydroxide filling part 2-2, heat from the jacket heater 2-4 covering the outside of the reactor 2-3 is easily conducted in a cross-sectional horizontal direction of the lithium hydroxide filling part 2-2, and heat uniformity in the horizontal direction of the lithium hydroxide filling part 2-2 is improved.

It is preferable that the heat transfer member 2-22 is disposed to be in contact with an inner wall of the lithium hydroxide filling part 2-2. This is for more efficient transmission of heat from the jacket heater 2-4 covering the outside of the reactor 2-3.

It is preferable that the heat transfer member 2-22 is provided with a plurality of communication holes. This is because, by providing a plurality of communication holes in the heat transfer member 2-22, the hydrogen sulfide supplied from the hydrogen sulfide supply pipe 2-5 is efficiently supplied to the lithium hydroxide filling part 2-2 through the plurality of communication holes.

A material of the heat transfer member 2-22 is not particularly limited, and the materials described above as the material of the reactor 2-3 can be used. However, it is preferable to use a material having excellent resistance to sulfurization and thermal conductivity, and for example, it is preferable to use aluminum, aluminum alloy, aluminum nitride, silicon nitride, or the like.

In addition, a shape of the heat transfer member 2-22 is not particularly limited, and for example, one or two or more porous plates selected from stainless steel plates or aluminum plates, which have a thickness of equal to or more than 20 mm and are provided with the communication hole, can be used.

As necessary, two or more of the above-described porous materials may be stacked and used as the heat transfer member 2-22.

From the viewpoint of balance between improvement of heat transfer efficiency and improvement of catalyst contact efficiency between sulfur vapor and catalyst, an area ratio of the communication hole provided in the heat transfer member 2-22 is usually equal to or more than 0.2% and equal to or less than 50%, preferably equal to or more than 0.5% and equal to or less than 40%.

A diameter of the communication hole provided in the heat transfer member 2-22 is usually equal to or more than 26 μm and equal to or less than 10,000 μm, preferably equal to or more than 45 μm and equal to or less than 5,000 μm.

### [Method for Producing Lithium Sulfide by Lithium Sulfide Producing Device of Embodiment 2-1 or 2-2]

A method for producing lithium sulfide using the lithium sulfide producing device of the embodiment 2-1 or 2-2 will be described.

First, the lithium hydroxide filling part 2-2 is filled with lithium hydroxide, and the lithium hydroxide filling part 2-2 filled with lithium hydroxide is heated by the jacket heater 2-4 as a heating unit.

In the lithium sulfide producing device 2-1 of the present embodiment, it is preferable that the inverted funnel-shaped lithium sulfide recovery member 2-6 also functions as a lithium hydroxide introduction part, and in this case, the lithium hydroxide is filled from the leg part 2-61 of the inverted funnel-shaped lithium sulfide recovery member 2-6. In this case, since dust generated when the lithium hydroxide is filled is guarded by an inner wall of the opening part 2-63, the filling of the lithium hydroxide can be performed more efficiently.

Next, hydrogen sulfide gas is supplied to the lithium hydroxide filling part 2-2 to bring the hydrogen sulfide gas into contact with the lithium hydroxide, and lithium sulfide is produced by the reaction between the lithium hydroxide and the hydrogen sulfide gas.

In the production process of lithium sulfide using the lithium sulfide producing device 2-1, a temperature of the lithium hydroxide filling part 2-2 in all regions is preferably equal to or higher than 150° C., more preferably equal to or higher than 170° C., and still more preferably equal to or higher than 200° C. When the temperature of the catalyst filling part in all regions is equal to or higher than the above-described lower limit value, a reaction rate between hydrogen sulfide gas and lithium hydroxide can be further improved.

In the production process of lithium sulfide using the lithium sulfide producing device 2-1, the temperature of the lithium hydroxide filling part 2-2 in all regions is preferably equal to or lower than 445° C., more preferably equal to or lower than 430° C., and still more preferably equal to or lower than 410° C. When the temperature of the catalyst filling part in all regions is equal to or lower than the above-described upper limit value, since it is possible to suppress the lithium hydroxide from melting, it is possible to suppress fusion between the lithium hydroxides to form lumps. As a result, a reaction between a reaction gas and lithium hydroxide can proceed more effectively.

d₅₀ of the lithium hydroxide in a weight-based particle size distribution measured by a laser diffraction scattering particle size distribution measurement method is preferably equal to or less than 1.5 mm, and more preferably equal to or less than 1.0 mm. When d₅₀ is equal to or less than the above-described upper limit value, a contact area between lithium hydroxide and the reaction gas is increased to promote the reaction, so that the amount of unreacted raw materials in the obtained lithium sulfide can be further reduced. As a result, higher purity lithium sulfide can be obtained.

In addition, d₅₀ of the lithium hydroxide in the weight-based particle size distribution measured by a laser diffraction scattering particle size distribution measurement method is preferably equal to or more than 0.1 mm, and more preferably equal to or more than 0.2 mm. When the average particle size is equal to or more than the above-described lower limit value, water generated in the reaction system can be prevented from adhering to lithium sulfide particles and causing the particles to stick. In addition, since it is possible to suppress the discharge of lithium hydroxide and obtained lithium sulfide together with the reaction gas, the exhaust gas treatment can be made simpler. Furthermore, since it is possible to suppress scattering of lithium hydroxide and obtained lithium sulfide by the reaction gas, the yield of lithium sulfide can be improved.

It is preferable that the lithium hydroxide is subjected in advance to dehydration of water of crystallization and drying of adhering water. As a result, since it is possible to suppress lithium hydroxide from agglomerating and suppress formation of hydrosulfide, the reaction between hydrogen sulfide gas and lithium hydroxide can proceed more effectively. Examples of dehydrating or drying the lithium hydroxide include a method of heating in the atmosphere, a method of heating while flowing a gas such as hydrogen, nitrogen, and argon gas, and a method of heating under reduced pressure.

The hydrogen sulfide gas may be a commercial product filled in a gas cylinder or the like, or may be produced by a hydrogen sulfide producing device connected upstream of the lithium sulfide producing device 2-1.

When a hydrogen sulfide producing device is connected upstream of the lithium sulfide producing device 2-1, it is possible to generate hydrogen sulfide gas in an amount necessary for producing lithium sulfide, which eliminates the need to store hydrogen sulfide gas separately. In addition, since the hydrogen sulfide gas can be generated as needed, high-purity hydrogen sulfide gas which does not degrade over time can be used for the reaction.

In the lithium sulfide producing device 2-1 of the present embodiment, since the inverted funnel-shaped lithium sulfide recovery member 2-6 is provided above the reactor 2-3, lithium sulfide produced in the reactor 2-3 can be recovered by sucking the lithium sulfide from a leg part 2-61 of the inverted funnel-shaped lithium sulfide recovery member 2-6. Therefore, the lithium sulfide can be recovered without dismantling the lithium sulfide producing device 2-1, recovery efficiency of lithium sulfide increases, and the lithium sulfide can be produced with high production efficiency.

In the lithium sulfide producing device 2-1 of the present embodiment, it is preferable that the inverted funnel-shaped lithium sulfide recovery member 2-6 is provided to be vertically movable, and by doing so, the inverted funnel-shaped lithium sulfide recovery member 2-6 can advance to the vicinity of the bottom of the reactor 2-3, and the lithium sulfide can be efficiently recovered.

### Modification Example

The lithium sulfide producing device of the present embodiment may include a member other than the members described above.

In addition, each part of the lithium sulfide producing device of the present embodiment may be integrally formed.

### [Uses of Lithium Sulfide]

The lithium sulfide obtained by the production method using the lithium sulfide producing device of the present embodiment can be suitably used, for example, as positive electrode active materials, negative electrode active materials, solid electrolyte materials, and intermediate raw materials for chemicals for batteries.

The embodiments of the present invention have been described above, but these are examples of the present invention and various configurations other than the above can be adopted.

### EXAMPLES

Examples 1 and 2 are examples of the embodiment 1-2 described above.

### Example 1

A lithium sulfide producing device 1-31 was produced using the following members. FIG. 1-5 is a vertical cross-sectional view of the producing device 1-31.
Reactor 1-3: SUS316L reaction tube in which an inner wall of 450 mm from a bottom surface was calorized with aluminum (inner diameter: 124 mm, height: 615 mm)
Heat-insulating member 1-36: laminate in which two sheets of aluminum plates (diameter: 116 mm, thickness: 0.5 mm, hole diameter: 5 mm, area ratio of hole diameter: 1.7%) were stacked on one sheet of aluminum punching metal (diameter: 116 mm, thickness: 0.5 mm, hole diameter: 0.5 mm, area ratio of hole diameter: 27.9%) at intervals of 8 mm
Lithium hydroxide support member 1-37: member obtained by stacking #100 aluminum mesh on #300 SUS mesh
Heat transfer member 1-22: aluminum plate material (diameter: 123 mm, thickness: 20 mm, hole diameter: 5 mm, area ratio of hole diameter: 9.7%)

The heat transfer member 1-22 was disposed below an interior of the reactor 1-3, and the lithium hydroxide support member 1-37 was disposed above the heat transfer member 1-22. The lithium hydroxide support member 1-37 was filled with 773 g of lithium hydroxide (particle size: 0.05 to 0.75 mm, not shown). The height of the filled lithium hydroxide was 100 mm. Next, the heat transfer member 1-22 was disposed on the upper portion filled with the lithium hydroxide.

A temperature sensor 1-9 inserted from a through hole for temperature sensor, provided in the heat-insulating member 1-36, reached the bottom surface of the lithium hydroxide filling part 1-2, that is, reached the lithium hydroxide support member 1-37, and the temperature sensor 1-9 was used to measure temperatures at each point in a horizontal central portion of the lithium hydroxide filling part 1-2.

Next, a mixed gas of hydrogen and hydrogen sulfide (hydrogen sulfide concentration: 13%) was supplied to the reactor 1-3 from the bottom of the reactor 1-3 through the hydrogen sulfide supply pipe 1-5 at a flow rate of 2.0 L/min. Next, the temperature of the jacket heater 1-4 was set to 410° C. to heat the lithium hydroxide filling part 1-2. As a result, hydrogen sulfide gas and lithium hydroxide were reacted to obtain lithium sulfide.

### Example 2

A lithium sulfide producing device 1-41 was produced in the same manner as in Example 1, except that an inverted funnel-shaped heat-insulating member 1-46 was used as the heat-insulating member instead of the heat-insulating member 1-36, and the temperature sensor 1-9 was inserted into a leg part of the inverted funnel-shaped heat-insulating member 1-46 to reach the lithium hydroxide support member 1-37, and lithium sulfide was produced.

A gap was formed between the temperature sensor 1-9 and an inner wall of the leg part of the inverted funnel-shaped heat-insulating member 1-46, so that the gap communicated between an upper space and a lower space of the inverted funnel-shaped heat-insulating member 1-46.

FIG. 1-6 is a vertical cross-sectional view of the producing device 1-41.

### Reference Example 1

A lithium sulfide producing device 1-51 was produced in the same manner as in Example 1, except that the heat-insulating member 1-36 and the heat transfer member 1-22 were not included, and as the lithium hydroxide support member 1-57, a member obtained by stacking #300 SUS mesh on a SUS punching metal having a diameter of 123 mm, a thickness of 0.5 mm, and a hole diameter of 0.5 mm, and further stacking #100 aluminum mesh thereon, and lithium sulfide was produced.

FIG. 1-7 is a vertical cross-sectional view of the producing device 1-51.

### Reference Example 2

A lithium sulfide producing device 1-61 was produced in the same manner as in Example 1, except that the heat-insulating member 1-36 was not included, and lithium sulfide was produced.

FIG. 1-8 is a vertical cross-sectional view of the producing device 1-61.

FIG. 1-9 shows a graph of temperatures of each point of the lithium hydroxide filling part 1-2, measured by the temperature sensor 1-9 after 150 minutes from the start of heating, in the lithium sulfide producing devices of Examples 1 and 2 and Reference Examples 1 and 2.

According to FIG. 1-9, in the lithium sulfide producing devices of Examples 1 and 2, a high temperature was maintained even in the upper portion of the lithium hydroxide filling part 1-2, and the lithium sulfide was stably produced with high efficiency. This is probably because the reaction site between the hydrogen sulfide gas and the lithium hydroxide was controlled at a high temperature with high precision.

Table 1 shows the maximum temperature Tax, the minimum temperature Tₘᵢₙ, and a difference between the two (Tₘₐₓ−Tₘᵢₙ) of temperatures measured at each point of the lithium hydroxide filling part 1-2.

TABLE 1

| | | | Reference | Reference |
|---|---|---|---|---|
| | Example 1 | Example 2 | Example 1 | Example 2 |
| Tₘₐₓ (° C.) | 359 | 357 | 327 | 354 |
| Tₘᵢₙ (° C.) | 327 | 329 | 266 | 277 |
| Tₘₐₓ − Tₘᵢₙ (° C.) | 32 | 28 | 61 | 77 |

According to Table 1, the value of Tₘₐₓ−Tₘᵢₙ was small in the lithium sulfide producing devices of Examples 1 and 2. That is, in the lithium sulfide producing devices of Examples 1 and 2, since the variation in temperature at each point of the lithium hydroxide filling part 1-2 was small, the lithium sulfide was stably produced with higher efficiency. This is probably because the reaction site between the hydrogen sulfide gas and the lithium hydroxide was controlled at a high temperature with high precision.

### REFERENCE SIGNS LIST

1-1 lithium sulfide producing device
1-2 lithium hydroxide filling part
1-3 reactor
1-4 jacket heater
1-5 hydrogen sulfide supply pipe
1-6 heat-insulating member
1-7 lithium hydroxide support member
1-8 hydrogen sulfide supply control valve
1-9 temperature sensor
1-10 gas discharge pipe
1-21 lithium sulfide producing device
1-22 heat transfer member
1-31 lithium sulfide producing device
1-36 heat-insulating member
1-37 lithium hydroxide support member
1-41 lithium sulfide producing device
1-46 heat-insulating member
1-51 lithium sulfide producing device
1-57 lithium hydroxide support member
1-61 lithium sulfide producing device
1-161 communication hole
1-162 through hole for temperature sensor
2-1 lithium sulfide producing device
2-2 lithium hydroxide filling part
2-3 reactor
2-4 jacket heater
2-5 hydrogen sulfide supply pipe
2-6 inverted funnel-shaped lithium sulfide recovery member
2-7 lithium hydroxide support member
2-8 hydrogen sulfide supply control valve
2-9 temperature sensor
2-10 gas discharge pipe
2-21 lithium sulfide producing device
2-22 heat transfer member
2-61 leg part
2-62 body part
2-63 opening part
2-61a leg part
2-62a conical body part
2-61b leg part
2-62b hemispherical body part
2-61c leg part
2-62c cylindrical body part
2-171 communication hole

This application claims priority based on Japanese Patent Application No. 2021-091946 and Japanese Patent Application No. 2021-091947 filed on May 31, 2021, the entire contents of which are incorporated herein by reference.

Regarding the above-described embodiments of the present invention, the present invention further discloses the following lithium sulfide producing device and method for producing lithium sulfide.
[A1]

A lithium sulfide producing device for producing lithium sulfide by reacting hydrogen sulfide with lithium hydroxide, the lithium sulfide producing device including:
a reactor having a lithium hydroxide filling part inside;
a heating unit for heating lithium hydroxide; and
a hydrogen sulfide supply member connected to the reactor.
in which an interior of the reactor includes a heat-insulating member above the lithium hydroxide filling part, and
an upper space and a lower space of the heat-insulating member communicate with each other in a part of the heat-insulating member or around the heat-insulating member.
[A2]

The lithium sulfide producing device according to [A1], further including:
a heat transfer member disposed in contact with or in close proximity to a bottom surface of the lithium hydroxide filling part.
[A3]

The lithium sulfide producing device according to [A1] or [A2],
in which an inner surface of the device is anti-sulfurized.
[A4]

A method for producing lithium sulfide, including:
reacting hydrogen sulfide gas and lithium hydroxide using the lithium sulfide producing device according to any one of [A1] to [A3].
[B1]

A lithium sulfide producing device for producing lithium sulfide by reacting hydrogen sulfide with lithium hydroxide, the lithium sulfide producing device including:
a reactor having a lithium hydroxide filling part inside;
a heating unit for heating lithium hydroxide; and
a hydrogen sulfide supply portion connected to the reactor,
in which an interior of the reactor includes an inverted funnel-shaped lithium sulfide recovery member above the lithium hydroxide filling member.
[B2]

The lithium sulfide producing device according to [B1],
in which the inverted funnel-shaped lithium sulfide recovery member also serves as a supply member for the lithium hydroxide.
[B3]

The lithium sulfide producing device according to [B1] or [B2],
in which the inverted funnel-shaped lithium sulfide recovery member is provided to be vertically movable.
[B4]

The lithium sulfide producing device according to any one of [B1] to [B3], further including:
a heat transfer member disposed in contact with or in close proximity to a bottom surface of the lithium hydroxide filling part.
[B5]

The lithium sulfide producing device according to any one of [B1] to [B4],
in which an inner surface is anti-sulfurized.

[B6]

A method for producing lithium sulfide, including:
reacting hydrogen sulfide gas and lithium hydroxide using the lithium sulfide producing device according to any one of [B1] to [B5].

1. A lithium sulfide producing device for producing lithium sulfide by reacting hydrogen sulfide with lithium hydroxide, the lithium sulfide producing device comprising:
a reactor having a lithium hydroxide filling part inside;
a heating unit for heating lithium hydroxide; and
a hydrogen sulfide supply member connected to the reactor.

2. The lithium sulfide producing device according to claim 1,
wherein an interior of the reactor includes a heat-insulating member above the lithium hydroxide filling part, and
an upper space and a lower space of the heat-insulating member communicate with each other in a part of the heat-insulating member or around the heat-insulating member.

3. The lithium sulfide producing device according to claim 2, further comprising:
a heat transfer member disposed in contact with or in close proximity to a bottom surface of the lithium hydroxide filling part.

4. The lithium sulfide producing device according to claim 2,
wherein an inner surface of the device is anti-sulfurized.

5. The lithium sulfide producing device according to claim 1,
wherein an interior of the reactor includes an inverted funnel-shaped lithium sulfide recovery member above the lithium hydroxide filling part.

6. The lithium sulfide producing device according to claim 5,
wherein the inverted funnel-shaped lithium sulfide recovery member also serves as a supply member for the lithium hydroxide.

7. The lithium sulfide producing device according to claim 5,
wherein the inverted funnel-shaped lithium sulfide recovery member is provided to be vertically movable.

8. The lithium sulfide producing device according to claim 5, further comprising:
a heat transfer member disposed in contact with or in close proximity to a bottom surface of the lithium hydroxide filling part.

9. The lithium sulfide producing device according to claim 5,
wherein an inner surface is anti-sulfurized.

10. A method for producing lithium sulfide, comprising:
reacting hydrogen sulfide gas and lithium hydroxide using the lithium sulfide producing device according to claim 1.
